(19) United States
(12) Patent Application Publication
(10) Pub. No.: US 2026/0365440 A1
(43) Pub. Date: Nov. 19, 2026

(54) METHOD FOR A PROCESSING UNIT FOR MEDICAL PRODUCTS AND PROCESSING UNIT FOR MEDICAL PRODUCTS

(71) Applicant: Aesculap AG, Tuttlingen (DE)

(72) Inventors: Arne Jansen-Troy, Stockach (DE); Andreas Elisch, Dunningen (DE); Allan Maas, Konstanz (DE); Daniel Kiessling, Villingen-Schwenningen (DE); Matthias Henke, Villingen-Schwenningen (DE); Massimo Fiamma, Radolfzell (DE); Sabrina Szabo, Engen (DE); Valentin Claus, Ueberlingen (DE)

(21) Appl. No.: 19/133,577

(22) PCT Filed: Nov. 23, 2023
(86) PCT No.: PCT/EP2023/082859

§ 371 Date: May 28, 2025

(30) Foreign Application Priority Data
Nov. 29, 2022 (DE) 10 2022 131 623.8

(51) Int. Cl. B65G 15/22

(52) U.S. Cl. CPC B65G 15/22; B65G 2201/0235

(57) ABSTRACT

A processing unit for medical devices performs automated handling of sterile containers, for example separating them into container components in preparation for subsequent processing by a robotic handling device, processing or storing container components and medical devices, such as pre-cleaning, cleaning, disinfection, sterilization, or storage using the appropriate processing or storage device, and transporting container components and medical devices. A transport chain is formed by devices of the processing unit and a motorized transport unit. A method for operating the processing unit can be used to process a sterile goods container and a medical instrument arranged in the sterile goods container.

### CROSS-REFERENCE TO RELATED APPLICATIONS

This application is the United States national stage entry of International Application No. PCT/EP2023/082859, filed on Nov. 23, 2023, and claims priority to German Application No. 10 2022 131 623.8, filed on Nov. 29, 2022. The contents of International Application No. PCT/EP2023/082859 and German Application No. 10 2022 131 623.8 are incorporated by reference herein in their entireties.

### FIELD

The present disclosure relates to a method for a processing unit for medical devices, as well as a processing unit for medical devices (AEMP).

### BACKGROUND

In medical care, higher demands are being placed continuously on efficiency while maintaining high quality and hygiene standards. This also applies to the processes for handling medical devices in a processing unit for medical devices (AEMP). Particular mention should be made to the separation and assembly, cleaning and sterilization, as well as storage and transport processes of the AEMP. In order to prevent errors during separation and assembly, for example of assembly and functional groups of sterile goods container systems in the AEMP, while at the same time increasing efficiency and reducing the workload for operating personnel, it is possible to automate these processes, for example with the aid of robots.

Relieving the burden on AEMP operating personnel with regard to transport processes is becoming increasingly important. These often involve non-value-adding, heavy work such as lifting as well as loading and unloading sterile goods container systems. By providing appropriate relief, the operating personnel can focus on more important processes that, at present, are difficult to automate.

Automated/robotic processes are known that describe the handling of individual assembly and functional groups of sterile goods container systems within an AEMP. These relate to individual logistical tasks such as the transport and loading and/or unloading of sterile goods containers, container trays as well as container lids from and into shelves, racks, and container transport trolleys.

In the specific application of an at least partially automated AEMP, the prior art includes shuttle systems for small-scale transport that enable automatic loading and unloading of cleaning and disinfection devices, as well as sterilizers with loading racks on which mesh baskets/containers with medical devices to be cleaned/disinfected/sterilized are located. Furthermore, sub-processes in transport are covered by additional conveyor belts or roller systems as well as driverless transport systems (AGVs). Such an AEMP is shown for example, in the video “Holistic solutions for the AEMP” by the manufacturer MMM Group.

The publication “Method for handling sterile goods container systems,” which shows a combination of robot cell and conveyor belt, goes back to applicant. Robotic manipulators separate the delivered sterile goods containers into their components: container tray, lid, filter, and mesh basket, which carries the contaminated medical device. Via the manipulator, the components can be delivered to the immediately adjacent conveyor belt for further transport. The reverse process, i.e., the delivery of cleaned, disinfected, or sterilized components via the conveyor belt and their compilation into sterile, ready-to-use sterile goods containers by means of the robot cell, likewise is disclosed.

### SUMMARY

In contrast, one object of the present disclosure is to provide a method for a processing unit for medical devices that enables more efficient transport within the AEMP. A second task of the present disclosure is to create a processing unit for medical devices whose transport process can be made more efficient.

The tasks are solved by a method and by a processing unit according to the present disclosure.

Specifically, the first task is solved by a method for a processing unit for medical devices (AEMP) comprising at least the following steps:
A step “Automated handling of a sterile goods container and/or a medical device located therein” by means of a robotic handling device of the AEMP. Automated handling depends in particular on the location and function of the at least one handling device. If the handling device is provided on an unclean side of the AEMP, in particular before pre-cleaning, the automated handling comprises in particular: removing the sterile goods container from a delivered sterile goods container system and separating the sterile goods container into its components, in particular into a container tray, a container lid and filter, and a basket or mesh basket containing the contaminated product. In the area between a cleaning and disinfection device (RDG) and a sterilization device of the AEMP, the automated handling of the handling device located there includes, in particular, loading a feed rack or trolley with packed baskets/mesh baskets/containers. If the handling device is located on the sterile side of the AEMP, automated handling includes, in particular, loading the sterile goods container system with sterile goods containers.
A step of “preparing the container/device using at least one processing device of the processing unit.” Alternatively or in addition to the ‘processing’ step, the method comprises a step of “storing the container/device using at least one storage device of the processing device.” The method may comprise a processing or storing step, a plurality of such steps, or a combination of different processing and storing steps. Processing includes, in particular: pre-cleaning in a pre-cleaning device, cleaning and disinfection in a cleaning and disinfection device (RDG) of the AEMP, packing in a packing device following the RDG, and final sterilization in a sterilization device. Storage includes, in particular: initial storage in an initial storage facility, buffer storage in an intermediate or buffer storage facility, and final storage in a final storage facility or bulk storage facility.
A step of “Transporting the container or its components and/or the device by means of a motor-driven transport unit in accordance with its intended use.” In particular, transport can be carried out by direct gripping or picking up by means of the transport unit, or indirectly by first placing the container, its components, and/or the device into loading means, such as loading racks or trolleys, which are then transported by way of the transport unit.

According to the invention, at least two of the AEMP devices form a transport chain in which, during an intended operation, manual transport steps, if any, are performed only within these at least two devices.

Within the AEMP, in particular within the AEMP transport chain, the medical device is placed in a mesh basket and is packaged in a sterile goods barrier at least at one point, in particular in at least one of the devices. The sterile goods barrier is preferably a sterile container.

In particular, the following should be mentioned in this regard: A packing device in which sterile goods containers with mesh baskets are packed for sterilization, the mesh baskets being loaded with medical devices, in particular instruments; a transport device by means of which the packed sterile goods containers are transported to a robotic handling device; the robotic handling device, via which a feeding device, in particular a feeding trolley, is filled with the packed sterile goods containers; and the sterilization device, in which the sterile goods containers are sterilized.

Accordingly, at this point, particularly in this facility, the sterile goods barrier, in particular the sterile goods container, is subject to robotic handling and/or transport.

Normal operation is characterized in particular by an adequate power supply and functioning of the AEMP and, in particular, the transport unit. In an inappropriate operation, in particular the power supply or functioning of the AEMP and, especially, of the transport unit is disrupted.

In the AEMP transport chain defined in this way, transport thus is performed at least outside the transport chain facility by means of a motor-driven transport unit, in particular in an automated manner. The method thus enables more efficient transport in the AEMP transport chain, which, moreover, relieves the operating personnel through motorized support.

Preferably, motor-assisted “transport” takes place via the transport unit between at least two processing devices and/or between the at least one processing device and the at least one handling device and/or between the at least one handling device and the at least one storage device. In a further development of the method, which enables even greater efficiency and an even higher degree of automation with regard to transport, the “transporting” step is carried out by means of the motor-driven transport unit between a large number, a plurality or between all devices of the AEMP.

In a further development, the method includes a step of “prioritizing at least one container/device.” This “prioritization” takes place in particular during the delivery of the contaminated container/device, pre-cleaning, cleaning and disinfection, packing, sterilization and/or storage or delivery of the sterilized container/device. In this way, the AEMP can respond as quickly as possible to the individual and urgent needs of different medical units.

To enable “prioritization,” a further development of the method includes a step of “controlling the transport unit via a control unit of the AEMP in such a way that the prioritized container/device is transported preferentially or more quickly”.

“Prioritization” can be carried out in particular by operating personnel in conjunction with the control unit. In the first case, the container/device to be prioritized can be identified by means of a scan. From this device, where the scan is performed, the prioritized container/device is given priority in processing and/or transport.

A processing unit (AEMP) for a medical device, in particular one arranged in a sterile goods container, is adapted to carry out a method according to at least one aspect of the preceding description. For this purpose, the AEMP has at least one robotic handling device for automated handling of the container and/or device, a processing device or a storage device for processing or storing the container and/or device, and a motor-driven transport unit for transporting the container and/or device during normal operation. According to the invention, at least two of the devices and the transport unit form a transport chain in which, during normal operation, manual transport, if any, is only provided within the at least two devices.

This means that manual transport steps, especially those that are dangerous to health, can be completely eliminated, at least outside the at least two devices in the transport chain, making the AEMP more efficient to operate and also reducing the workload for operating personnel.

Preferably, the transport unit is designed such that it can be operated manually in non-normal operation, for example in the event of a power failure or malfunction, or that a manually operable bypass transport path is provided for it.

According to the disclosure, the transport chain is preferably uninterrupted. It is formed by the existing AEMP devices mentioned above, with the motor-driven transport unit closing the distances between at least two AEMP facilities.

In a further development, the transport chain is formed by a large number or even a plurality of AEMP facilities, which further increases the efficiency of transport and reduces the workload of the operating personnel to an even greater extent.

In a further development, the transport chain extends from an entry of the AEMP for contaminated containers and/or contaminated medical devices to an exit of the AEMP. In other words, all facilities are links in the transport chain. This allows uninterrupted motorized transport between all AEMP facilities, which maximizes transport efficiency and greatly reduces the workload on the operating personnel.

In a further development, at least one section of the transport unit has two parallel transport paths, in particular to implement the aforementioned step of “prioritizing at least one container/device.” One transport path is for transporting prioritized containers/devices, the other for transporting non-prioritized containers/devices. This allows prioritized containers/devices to overtake non-prioritized ones, and the AEMP can respond very flexibly and quickly to the needs of medical units, especially hospitals, by faster guiding through prioritized containers.

For prioritization purposes, a further development of the AEMP has a user interface so that the container/device to be prioritized is identified by means of a scan and given priority in processing and/or transport from the facility where the scan is carried out.

In order to further increase flexibility and speed, in a further development at least one of the transport paths can be operated in both transport directions.

In an alternative or supplementary further development, at least one section of the transport unit has only one transport path that can be operated in opposite transport directions. Prioritization is then achieved by preferentially fitting and/or taking off the prioritized container/device.

The AEMP has at least one control unit which is designed in such a way that it can be used to automatically control at least the at least one handling device and the motorized transport unit-preferably also the automatic control of at least one automated processing device or storage device. The control unit is provided with at least one machine-readable data carrier on which the previously described method is stored in the form of a corresponding program.

Preferably, the control unit performs automatic control in the event of prioritization.

The at least one handling device and the at least one processing device or storage device each occupy a section of the floor space of the AEMP. Preferably, the container and/or device is/are transported by the transport unit at least outside the floor space sections.

Existing AEMPs involve manual activities, particularly on the floor space of the pre-cleaning device and the storage device, which are performed by manual transport steps, for example by passing/pushing along over short distances. In a further development, the transport unit is effective at least in sections within the floor space section and can thus support manual transport there.

In a further development, at least one of the processing or storage devices can be or is connected to at least one of the robotic handling devices independently of the transport unit, in that the robotic handling device delivers the container/device directly to the device. In this way, for example, the spatial proximity of the handling device can be used to keep the transport unit small, which reduces the technical effort required for the transport unit. Alternatively or in addition, at least one of the processing or storage devices can be or is connected to the robotic handling device for transport by means of the transport unit.

In order to organize transport of the container/device in an orderly and systematic manner, the transport unit has transportable feeding devices, for example, trolleys or racks, in which containers/container sections/devices can pass through the processing stages.

The feeding devices can be employed, for example, between the robotic handling device and the pre-cleaning device, the pre-cleaning device and the RDG, the RDG and the packing device, the packing device and the sterilization device, the sterilization device and the robotic handling device, and/or between the robotic handling device and the storage device.

In particular, in order to be able to carry out the prioritization described above, but also, for example, to represent redundancy, the transport unit has two tracks, at least in sections. The flexibility of the transport unit, in particular with regard to prioritization or in the event of a track failure, is further increased if the transport unit has at least one crossing or a crossing point, in particular of its tracks.

In order to safely separate motorized/automated transport paths of the transport unit from human work areas or work routes, a transport route or path of the transport unit is arranged, supported, or suspended on the ceiling, at least in sections, in a further development. Alternatively or in addition, it can naturally be arranged, supported, or suspended, at least in sections, on the floor,.

In a further development, the transport unit has at least one running rail arrangement, a belt, a belt arrangement, a shuttle, a movable gripper, a movable robot arm, and/or a movable hoist. In its specific design, it has a combination of the aforementioned transport means. Depending on the location of use or equipment to be connected for transport, a suitable means of transport is used. For example, after separation of the container into a tray, lid, filter and mesh basket by the robotic handling device, the mesh basket is advantageously transported by a movable robot arm involved in the separating process.

In order to enable direct transport between the robotic handling device and a plurality of processing devices, i.e., without the intervention of the transport unit, the processing devices, in a further development, are arranged adjacent to the handling device. In a preferred embodiment, they are disposed in a space-saving manner around or at least partially around the robotic handling device.

In an alternative or supplementary configuration, processing devices are arranged around an end point or junction of the transport unit. This also turns out to save space and enables efficient distribution of the container/container components/devices between a plurality processing devices operating in parallel.

With the same advantage of efficient use of space and distribution, according to a further development, the at least one robotic handling device is arranged at another end point or junction of the transport unit.

The processing devices, in particular their longitudinal axes, can extend, for example, in a radial, star-shaped, tangential, or circumferential manner relative to the handling device, the node, or the end point.

Alternatively or in addition, several processing devices are distributed along the transport unit in the direction of transport and/or extend, in particular with their longitudinal axis, parallel or transverse to the direction of transport.

The arrangement(s) and/or extension(s) may have mixed forms, in particular for optimizing space utilization and distribution.

In a preferred embodiment, the AEMP has at least one pre-cleaning device, cleaning device, disinfection device, packing device, sterilization device and/or commissioning device as processing device(s).

Depending on the area of the AEMP, it is advantageous that the at least one robotic handling device is transport connected via the transport unit to the at least one processing device or storage device, or that the at least one robotic handling device is transport connected to the transport unit via the at least one processing device or storage device.

In an advantageous further development, the at least one handling device can be operated such that cleaned/disinfected/sterilized products and/or container components are delivered in a defined manner and assembled into a closed sterile container via the handling device. Preferably, the transport unit is designed such that the aforementioned components are made accessible to a manipulator of the handling device in a defined manner.

The features of the following sections of the general description are disclosed with direct reference to the processing unit (AEMP) designed in accordance with the invention. In addition, they are of course also to be comprehended in the context of the previously disclosed further developments of the processing unit according to the invention.

According to one possible design of the processing unit, the at least one robotic handling device overlaps with the at least one transport device at least with regard to a respective base area section. This overlap makes it possible to transfer the medical device to be processed between the robotic handling device and the transport device particularly efficiently, i.e., in particular via the shortest route.

In addition or alternatively, the at least one robotic handling device overlaps with the at least one transport device with regard to a respective operating range, which makes transfer even more efficient.

According to this publication, the operating range is defined as a section of space extending from the respective base area and in which a robotic handling device of the robotic handling direction or transport means of the transport device is effective.

The section of space can extend from the base area, particularly in the direction of gravity, at least in sections, in a cylindrical, spherical, concave, convex, and/or free-form manner.

The section of space of the at least one robotic handling device is formed, according to one possible further development, at least in sections by the working space of a robot (handling means) of the robotic handling device. In particular, the working space protrudes beyond an edge of the base area of the robotic handling device.

The space section of the at least one transport device is formed, according to one possible further development, at least in sections by the working space of a gripper or transport robot (transport means) or the like of the transport device. In particular, this space section protrudes beyond an edge of the base area of the transport device.

The working space is formed, for example, by an enveloping surface of the maximum reachable working points of the robot, transport robot, or gripper.

In an alternative or complementary design, at least two transport devices of the processing unit overlap with regard to their respective base areas, which allows for transfer that is even more efficient.

In addition or alternatively, the at least two transport devices overlap with regard to their respective operating areas, which allows for even more efficient transfer.

The overlap of the base areas and/or effective ranges of the at least two transport devices, according to a further development, is formed such that the transport paths of the at least two transport devices run parallel to each other at least in sections, or that these transport paths are superimposed or subordinate to each other at least in sections, in particular with respect to the direction of gravity.

Overlapping or subordinating is implemented in accordance with a possible design by arranging one of the transport paths in the area of intersection with reference to gravity above the other transport path. Preferably, at least in the area of intersection, the upper transport path is arranged or suspended on the ceiling side and the lower transport path is arranged or supported on the floor side.

The intersection of the base areas and/or effective ranges of the at least two transport devices is implemented in accordance with an alternative or supplementary further development such that the transport paths of the at least two transport devices are tangent or cross or overlap, in particular with their end sections.

### BRIEF DESCRIPTION OF THE DRAWINGS

FIG. 1 shows a schematic representation of a processing unit for a medical device according to the present disclosure.

FIG. 2 shows a section of the pre-cleaning of the processing unit according to FIG. 1 in a perspective view.

FIGS. 3a and 3b show an unclean side of the processing unit according to FIG. 1 in accordance with an embodiment, in a perspective view and in a top view.

FIG. 4 shows an unclean side of the processing unit according to FIG. 1 in accordance with an embodiment, in a perspective view.

FIG. 5 shows an unclean side of the processing unit according to FIG. 1 in accordance with an embodiment, in a perspective view.

FIG. 6 shows an unclean side of the processing unit according to FIG. 1 in accordance with an embodiment, in a perspective view.

FIG. 7 shows a clean side of the processing unit according to FIG. 1 in accordance with an embodiment, in a perspective view.

FIG. 8 shows a clean side of the processing unit according to FIG. 1 in accordance with an embodiment, in a perspective view.

FIG. 9 shows a sterile side of the processing unit according to FIG. 1 in accordance with an embodiment, in a perspective view.

FIG. 10 shows a schematic representation of a sequence of method steps according to the present disclosure.

### DETAILED DESCRIPTION

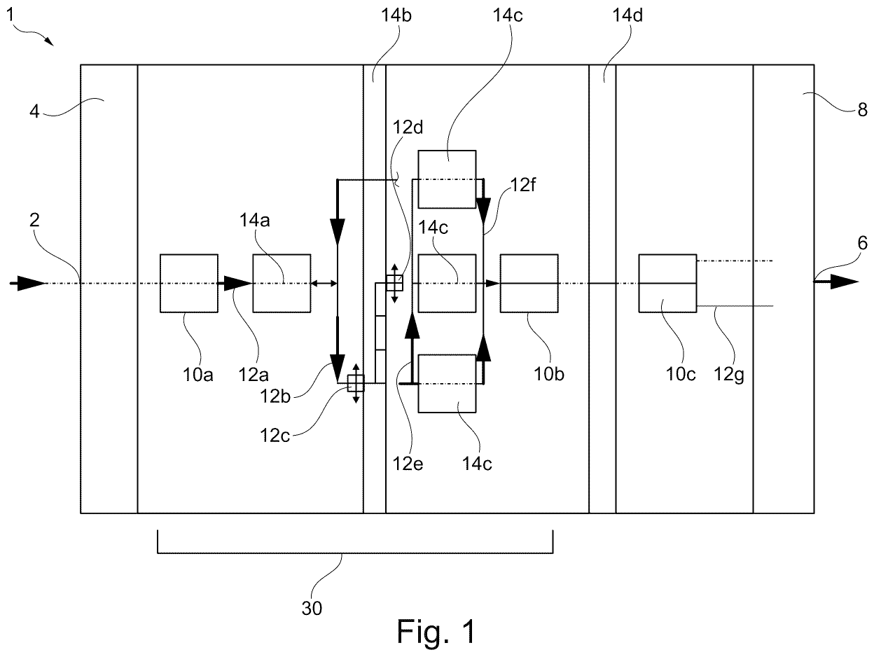

According to FIG. 1, a processing unit 1 for a medical device-hereinafter referred to as AEMP-, according to the invention has an entry 2 on an unclean side with an entry storage 4 for storing containers with contaminated medical devices, and an exit 6 on its sterile side with an exit storage 8 for storing containers with processed/sterilized medical devices. From entry 2 to exit 6, the product to be processed in the AEMP 1 passes through several transport, handling, and processing devices with corresponding transport, handling, and processing steps. According to FIG. 1, manual transport is depicted by a dashed line, and motorized, automated transport is shown with a solid line.

The entry storage 4 is linked to a pre-cleaning area with a first robotic handling device 10a, via which the containers delivered from entry storage 4 are separated into their container components and the medical device to be processed. Via a first transport device 12a of a motor-driven transport unit 12 the first handling device 10a is transport connected to a first processing device-in the embodiment shown in FIG. 1, this is a manual pre-cleaning device 14a.

In the embodiment shown according to FIG. 1, the first transport device 12a is designed as a prehensile robot arm or robot arm arrangement movable on the ceiling. Alternatively, it can be designed as a belt or belt arrangement. By arranging the first processing device 14a directly adjacent to the first handling device 10a, the first transport device even can be omitted completely.

Transport of the container/container components/device within the pre-cleaning device 14a is conveniently carried out manually as shown in FIG. 1, but can alternatively be carried out mechanically or at least mechanically assisted by the transport unit 12. Via a second and third transport device 12b, 12c of the transport unit 12 the pre-cleaning device 14a is transport connected to a second processing device—in the embodiment according to FIG. 1, this is a cleaning and disinfection device 14b (RDG). According to FIG. 1, the second transport device 12b is formed as a bi-directionally operable conveyor belt or a correspondingly operable belt arrangement. The third transport device 12c is designed as a shuttle that can be moved along the RDG 14b for loading from entry to entry.

The RDG 14b separates the unclean side from the clean side of the AEMP 1. Via a fourth and fifth transport device 12d, 12e of the transport unit 12, exits on the clean side of the RDG 14b are transport connected to a third processing device 14c—in the embodiment shown, a packing device 14c for packing the containers for the upcoming sterilization. According to FIG. 1, the fourth transport device 12d is formed analogous to the entry side of the RDG 14b by a shuttle that can be moved from exit to exit for unloading the RDG 14b. The fifth transport device 12e is formed by a ceiling-supported crane.

According to FIG. 1, the packing device 14c is transport connected to a second robotic handling device 10b via a sixth transport device 12f, which loads the feed trolleys of the AEMP 1 with the packed containers.

According to FIG. 1, the feed trolleys are moved manually from the robotic handling device 10b to the sterilization device 14d, and fed into the sterilization chambers thereof. On the exit side of the sterilization device 14d, the feed trolleys are removed manually and fed to a further robotic handling device 10c. On the one hand, this fills transport trolleys with selected or prioritized containers, which can be diverted manually for direct use. On the other hand, it also places containers with lower priority on a seventh transport device 12g of the transport unit 12, which is designed as a conveyor belt and is used to fill mass storage 8. A transport chain 30 according to the invention, in which manual transport takes place exclusively within devices 14a and 14c and not between devices 10a, 14a, 14b, 14c, 10b of the AEMP 1, thus extends from the first handling device 10a to the second handling device 10b.

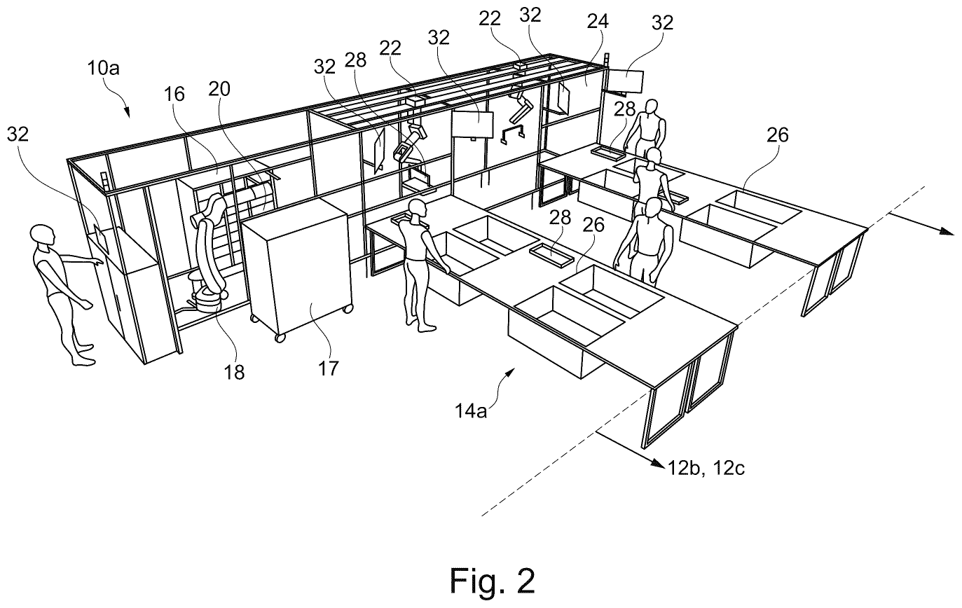

FIG. 2 shows a pre-cleaning area of an AEMP according to the invention in accordance with an embodiment. On the entry side, the first handling device 10a, designed as a robot cell, is provided with a robot 18 with six degrees of freedom for gripping, unloading and separating sterile goods containers 20 delivered in container transport trolleys 16. The robot cell 10a can be equipped with interfaces 32 for status display and information on the sterile goods containers 20, mesh baskets 28, instruments, and other information important for the operating personnel. The robot 18 grips the container 20 and removes it from the transport trolley 16. One of two further robots 22 in the robot cell 10a drives up, interacts with the first robot 18, and separates the container 20 into its components: lid, tray, filter, as well as a mesh basket 28 containing contaminated medical devices. The lid, tray, and filter are stowed away directly into a loading trolley 17 intended for manual transport to the RDG by robot 22. The other robot 22 of robot cell 10a, which is located on the ceiling and can be moved in a translational manner, takes over the mesh basket 28 with the medical device to be pre-cleaned and places it directly on one of the washing tables 26.

In this way, an effective range of the robotic handling device 10a (robot cell) overlaps with an effective range of the pre-cleaning device 14a, so that the transfer between the robotic handling device 10a and the pre-cleaning device 14a is efficient.

The first transport device 12a, as shown in the embodiment according to FIG. 1 between the first handling device 10a and the pre-cleaning device 14a, is therefore omitted in the embodiment shown in FIG. 2. The washing tables 26 of the pre-cleaning device 14 a extend transversely to the transport path of the robots 22 and to the robot cell 10a. The AEMP personnel remove the devices from the mesh baskets 28 and carry out pre-cleaning. For safety reasons, in particular with regard to hygiene and collision requirements, a workspace for the robots 18, 22 and thus the entire robot cell 10a is separated from the AEMP personnel by partitions 24, ideally made of transparent, disinfectable plastics that can be wiped. Safety mechanisms such as collision protection, distance measurement sensors, and other technology used in cooperating and collaborating robots are used herein. The arrangement of the washing tables 26 of the pre-cleaning device 14a transverse to the robot cell 10a remarkably enables particularly effective separation and rapid feeding of the components for pre-cleaning and further processing steps, solely by means of the existing robotic handling device 18, 22 and without the need for additional transport mechanisms.

Further transport devices (for example, such as 12b, 12c according to FIG. 1), via which the washing tables 26 are transport connected to the RDG 14b, are included in the embodiment according to FIG. 2, but are merely symbolized here by the two adjacent arrows and reference signs 12b, 12c. A transport chain designed according to the invention, in which manual transport takes place exclusively within the processing device 14a of the transport chain, is thus formed, according to FIG. 2, by the robot cell 10a, the washing tables 26 and transport devices 12b and 12c (not shown).

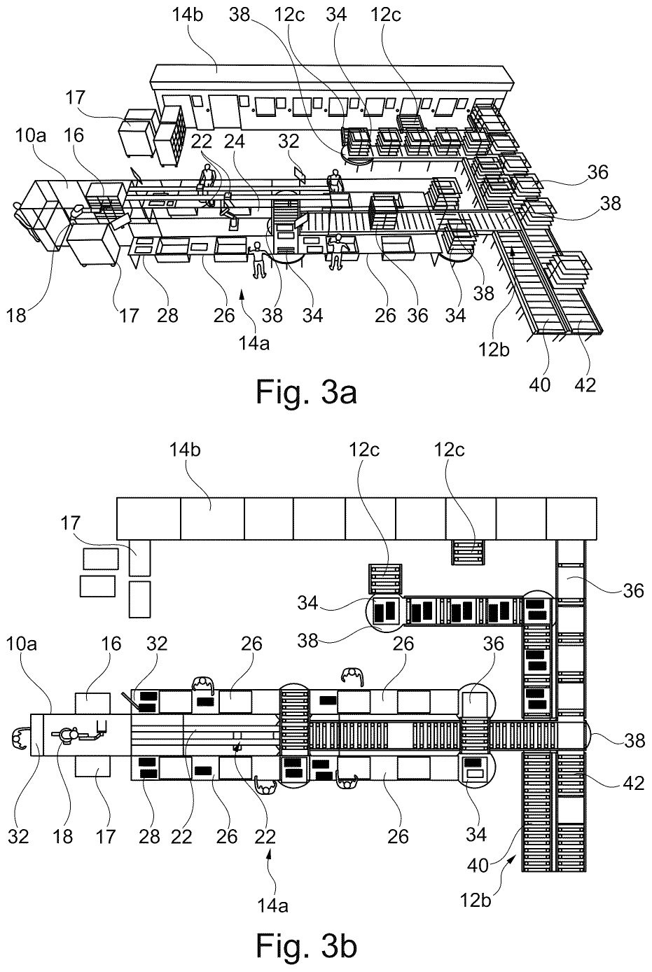

FIGS. 3a and 3b show an embodiment with a transport chain designed according to the invention from the robot cell 10a, via the washing tables 26 and the transport devices 12b and 12c, to the RDGs 14b. Departing from the embodiment shown in FIG. 2, an arrangement and extension of the washing tables 26 along the robot cell 10a and parallel to the direction of travel of the robots 22 is proposed herein. This allows the robots 22 to move directly to each washing station of the washing tables 26 and supply them. Unlike the embodiment shown in FIG. 2, the robot cell 10a and the second transport device 12b moreover overlap in terms of their base areas and thus their operating ranges.

In this way, transfer between the robotic handling device 10a and the second transport device 12b is efficient.

The second transport device 12b is configured as a conveyor belt, in particular as a belt conveyor or alternatively as a roller conveyor, which is operable in two transport directions, branched and positioned beneath the transport path of the two robots 22 in sections. Feeding racks 34 are stored and transported on a track 40 of the conveyor belt 12b that is operable in two directions. These racks are loaded with pre-cleaned mesh baskets 28 containing pre-cleaned instruments (pre-cleaned medical devices) and are fed to the RDGs 14b. On another track 42, empty loading racks 36 are stored and transported, which come back cleaned and disinfected from the RDGs. They can then be fed again to the washing tables 26. The second transport device 12b (conveyor belt) is transport connected to the third transport device 12c (entry-side shuttle of the RDG 14b) and has automated turnstiles 38 for changing the direction and track of the loading racks 34, 36. In the configuration shown in FIGS. 3a, 3b, it is noteworthy that the loaded loading racks 34 can be fed to the RDGs 14b very quickly without needing to make use of additional transport systems, such as manual conveyor systems like transport trolleys. With the help of the conveyor belt arrangement shown in FIGS. 3a and 3b, in particular the turnstiles 38, it is also possible, among other things, to carry out fully automated loading, which also enables storage and position changes of loading racks 34, 36 relative to each other. To prevent the robots 22 and the loading racks 34, 36 from colliding in the area where the robot cell 10a overlaps with the second transport device 12b, the AEMP is equipped with anti-collision sensors and programming prioritization, as well as interfaces to other logistics software. The description of the further embodiments is based solely on a respective perspective view. According to FIGS. 3a and 3b, a transport chain designed according to the invention is thus formed by the robot cell 10a, the washing tables 26 and the transport devices 12b and 12c.

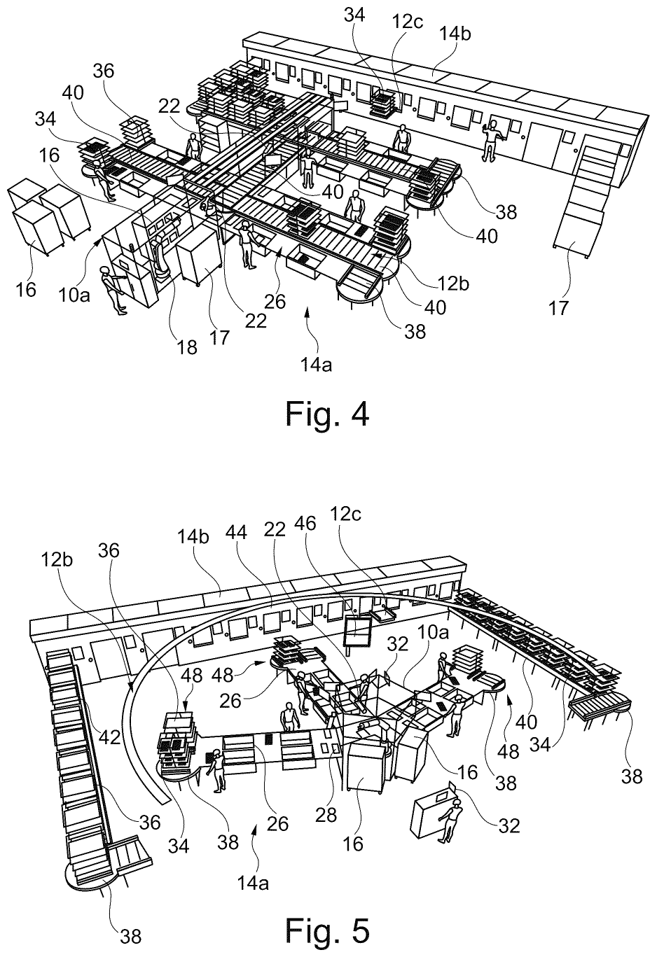

FIG. 4 shows a scaling of the embodiment according to FIGS. 3a and 3b with a modified arrangement of the washing tables 26 transverse to the transport path of the robots 22. This allows the number of washing stations along this path to be increased from 8 to 12. Of course, a further increase (upward scaling) or reduction of the number is also possible (downward scaling). According to FIG. 4, a transport chain designed according to the invention thus is formed by the robot cell 10 a, the washing tables 26, and the transport devices 12b and 12c.

It is to be seen in FIG. 4 that the second transport device 12b, i.e. its conveyor belt 40, is partially overlapped by the robotic handling device 10a, more precisely by the transport path of the robot 22, which ensures efficient transfer between the robotic handling device 10a and the second transport device 12b.

According to the embodiment shown in FIG. 5, instead of the conveyor belts for supplying the entry-side shuttle 12c of the RDGs 14b, a second transport device 12b is used, which is partly ceiling-supported and partly floor-supported. The ceiling-supported section is formed by a circular or circular section rail 44 as a transport path, on which a motor-driven retractable or extendable unit 46 runs, which can move to specified end points 48 of the washing tables 26 and of conveyor belts 40, 42 in order to deliver/pick up empty/full loading racks there. The conveyor belts 40, 42 represent the floor-supported section of the second transport device 12b. In this configuration, the robot cell 10a is placed centrally to washing tables 26 arranged in a star-shaped manner, at other end points. This has the advantage that the translational axis of the robots according to the previous figures is omitted. This results in a more material-saving and faster provision of the mesh baskets. According to FIG. 5, the mesh baskets 28 are processed from inside to end points 48. The washed loading racks 36 are provided on a conveyor belt at the left end of rail 44. Here too, the conveyor belts have the aforementioned turnstiles 38 for changing direction, changing lanes, and overtaking prioritized loading racks. As an alternative to transfer to the conveyor belt provided at the right end of rail 44, transfer of prioritized loading racks 34 filled with mesh baskets can be carried out directly from the pullout 46 to the shuttle 12c. For this purpose, a center axis of the shuttle 12c must be aligned with a radius of the rail 44. In order not to cross the paths of the employees and thus ensure an independent workflow, it is also proposed to additionally equip the pullout 46 with a vertical axis that can be moved automatically, so that the loading racks 34, 36 can be transported as close to the ceiling as possible. In this configuration, the loading racks 34, 36 are placed on the washing tables 26 and the shuttle 12c, respectively, and are moved upwards during transport. According to FIG. 5, a transport chain designed according to the invention is thus formed by the robot cell 10a, the washing tables 26, the ceiling-supported section and the floor-supported section of the second transport device 12b, and the third transport device 12c.

According to FIG. 5, the effective range of the second transport device 12b thus overlaps with that of the turnstiles 38 of the conveyor belts 40, 42, so that the transfer between the second transport device 12b and the conveyor belts 40, 42 is efficient. In addition, the operating range of the centrally located robotic handling device 10a overlaps with the base areas and operating ranges, respectively, of the surrounding washing tables 26, i.e., the first processing device 14a.

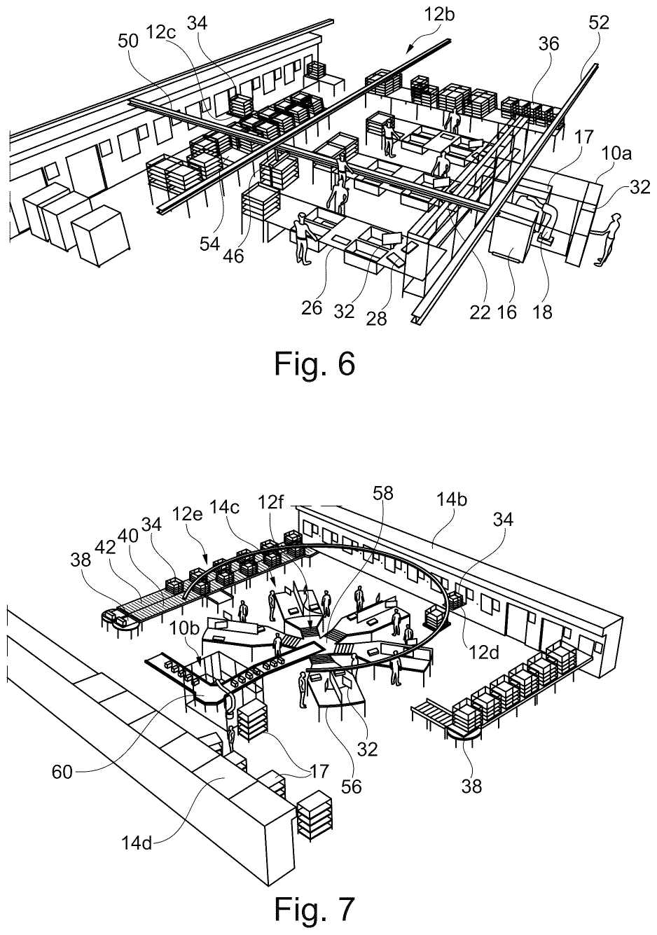

In contrast to the last embodiment described, the transport device 12b according to the embodiment shown in FIG. 6 is not limited in one degree of freedom, but can move in two degrees of freedom along rails 50, 52 that cross orthogonally on the ceiling side, similar to a bridge crane or stacking crane with a trolley. Parallel rails 52 form a crane runway on which the rail 50 can run as a crane bridge. The pullout 46, which can be moved on the crane bridge 50, can thus supply the entire base area between the robot cell 10a and the RDGs 14b with loading racks and is movable vertically. The loaded 34 and empty loading racks 36 can thus be picked up directly by the transport device 12b using a hook or gripper of the pullout 46, moved and placed on a table-like storage place 54 or fed to the shuttle 112c. A significant advantage of this configuration and technology is the reduction of conveyor belts to a minimum. Remarkably, these table-like storage places 54 make it very easy to prioritize the loading racks 34, 36. To do this, they simply are approached and gripped directly by the transport device 12b without needing to move any other racks. In this configuration, the washing tables are arranged at right angles to the travel axis of the robots 22, similar to FIGS. 2 and 4. The robots 18, 22 can separate the sterile goods containers and feed the mesh baskets 28 directly to the washing tables 26. A transport chain designed according to the invention is thus formed, according to FIG. 6, by the robot cell 10a, the washing tables 26, the second transport device 12b supported solely by the ceiling, and the third transport device 12c.

Thus, according to FIG. 6, the operating range of the third transport device 12c (of the shuttle 12c) overlaps with the operating range of the second transport device 12b, the operating range of the second transport device 12b overlaps with the base areas and effective range of washing tables 26 (first processing device 14a), and the base areas and effective ranges of washing tables 26 (first processing device 14a) overlap with the base area and the effective range of the robotic handling device 10a, so that the transfer in each case is carried out efficiently.

In the event of a malfunction of an AEMP according to the embodiments shown in FIGS. 2, 3, 4, and 6, all employees have access to the mesh baskets 28 by simply opening the partition walls 24 of the robot cell 10a. Access is provided by simple mechanically operable doors or flaps of the partition walls 24. These can also be used to access the interior of the robot cell 10a for cleaning and disinfection. In the event of a failure of the second transport device 12b of the embodiments shown in FIGS. 1 to 6, the transport of the pre-cleaned mesh baskets 28 can continue to be maintained manually with the aid of loading rack transport trolleys, and the RDGs 14b can be approached and loaded directly. This is preferably done via the turnstiles 38, to which the loading rack transport trolleys are pushed and to which the loading racks can be transferred. In the embodiment according to FIG. 7, which shows an area of an AEMP between the RDGs 14b and the sterilization unit 14d, a star-shaped arrangement of packing tables 56 around a junction 58 of a belt arrangement is proposed for the processing device 14c designed as a packing device, by analogy to the embodiment shown in FIG. 5. The filled loading racks 34 emerging from the RDGs are fed via the shuttle 12d to a two-track belt arrangement with turnstiles 38 acting as an intermediate storage facility (FIG. 7, left), which, as described above, enables prioritization, and from there via the ceiling-side, partially circular transport device to outer end points of packing tables 56. Subsequent to packing, empty loading racks 36 are picked up again by the transport device and are supplied to the conveyor belt on the right in FIG. 7 and returned to the process. The ready-packed mesh baskets and/or sterile goods containers are fed via short conveyor belts to junction 58 and an adjoining conveyor belt, transported from there and picked up at the other end point 60 by the handling device 10b (robot cell 10b). Its robot 18 can feed the packed sterile goods containers and/or mesh baskets to a loading trolley 17 for loading into the sterilization device 14d or, via an adjacent conveyor belt, to a further mass storage. According to FIG. 7, a transport chain designed according to the invention thus is formed by the RDGs 14b, the fourth transport device 12d, the floor-supported and ceiling-supported sections of the fifth transport device 12e, the packing tables 56, and the sixth transport device 12f.

Thus, according to FIG. 7, the base areas and/or effective ranges of the shuttle overlap at least between the second processing device 14b and the fourth transport device 12d, and the fourth transport device 12d and the fifth transport device 12e, as well as the fifth transport device 12e and the packing tables 56, as well as the sixth transport device 12f and the second robotic handling device 10b, so that the respective transfer takes place efficiently.

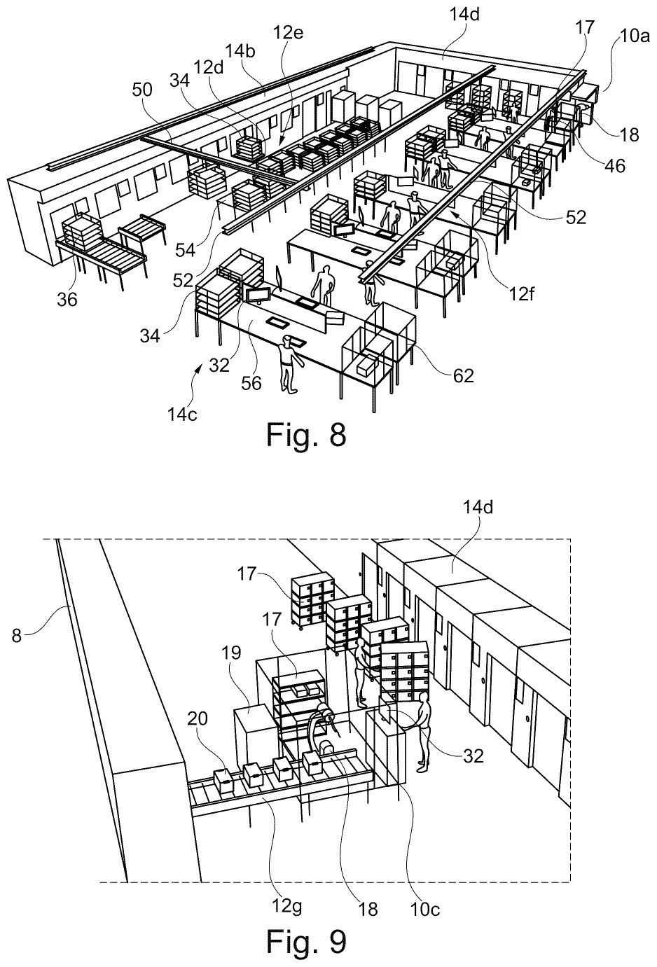

In the embodiment according to FIG. 8 which, as already FIG. 7, shows an area of an AEMP between the RDGs 14b and the sterilization unit 14d, a fifth transport device 12e on the ceiling side is proposed for processing device 14c designed as a packing device, by analogy to the embodiment shown in FIG. 6, which is not restricted in any degree of freedom. Unlike in the previous embodiments, the RDGs 14b are arranged at right angles to the sterilization unit 14d instead of parallel and opposite each other. Between the fifth and sixth transport devices 12e and 12f on the ceiling side, the packing tables 56 are disposed in parallel, staggered on the floor side. In addition, the fifth transport device 12e has a vertical degree of translational freedom in order to be able to move loaded and empty loading racks 34, 36 with the aid of a hook or gripper and place them on a table-like storage place 54 or pick them up from the shuttle 12d. A significant advantage of this configuration is the reduction of conveyor belts to a minimum. It is also proposed here that the table-like storage places 54 are arranged in two rows so that they can also be accessed by transport trolleys in the event of a malfunction of transport devices 12d, 12e, 12f. Mesh baskets and/or sterile goods containers ready packed at the packing tables 56 are manually loaded into transport racks 62, which are picked up by the sixth transport device 12f and fed to the second handling device 10b, configured as a robot cell. The robot 18 located there can supply the sterile goods containers and/or mesh baskets to a loading trolley 17 for the sterilizers or to a store and/or buffer store. In this configuration, prioritization likewise can be realized using branching conveyor belts in combination with turnstiles. According to FIG. 8, a transport chain designed according to the invention thus is formed by the RDGs 14b, the fourth transport device 12d, the ceiling-supported fifth transport device 12e, the packing tables 56, and the sixth transport device 12f.

Thus, according to FIG. 8, the base areas and/or effective ranges of at least the fourth transport device 12d (shuttle of the second processing device 14b) and the fifth transport device 12e, as well as the fifth transport device 12e and the packing tables 56 of the processing device 14c overlap, so that the respective transfer takes place efficiently.

FIG. 9 finally shows an embodiment of an AEMP in the area after sterilization 14d, in particular the picking of the sterilized container(s)/product(s). Loading trolleys 17 with the sterilized containers 20 are taken from the individual sterilizers of sterilization 14d and are supplied manually, alternatively automatically to the third handling device 10c, which is designed as a robot cell. The robot 18 there removes them from the loading trolleys 17 and feeds them to a container transport trolley 19 or a seventh transport device 12g designed as a conveyor belt, which fills mass storage 8. Here too, prioritization can be realized by means of branching conveyor belts in combination with turnstiles.

Thus, according to FIG. 9, the base area and the effective range of the third robotic handling device 10c overlap with the base area and the effective range of the seventh transport device, so that the transfer is performed efficiently.

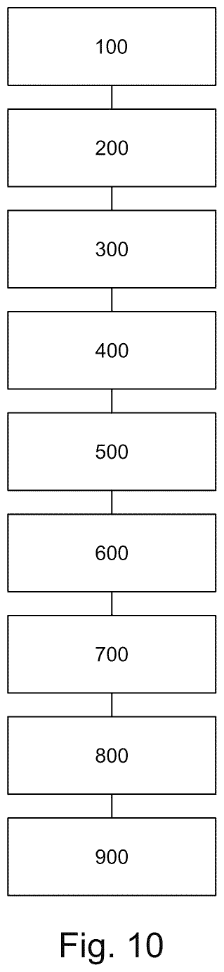

According to FIG. 10 and against the background of AEMP 1 according to FIG. 1, the method according to the invention comprises at least the steps of “separating the sterile goods containers by means of handling device 10a” 100, “transporting mesh baskets including the medical device by means of the first transport device 12a” 200, “pre-cleaning the medical device in the pre-cleaning device 14a 10a” 300, “transporting the pre-cleaned medical device by means of the second and third transport devices 12b, 12c to the RDGs 14b” 400, “cleaning and disinfecting the medical device by means of the RDGs 14b” 500, “transporting the cleaned and disinfected medical device from the RDGs by means of the fourth and fifth transport devices 12d, 12e to the packing device 14c” 600, “Packing sterile goods containers for sterilization in the packing device 14c” 700, “transporting the packed sterile goods containers to the second handling device 10b using the sixth transport device 12f” 800 and “filling of loading trolleys including the packed sterile goods containers by way of the second handling device 10b” 900. In accordance with the method of the invention, i.e., in the intended operation of the AEMP at least along the transport chain from the first handling device 10a to the second handling device 10b, a manual transport step takes place only within the processing devices 14a (pre-cleaning) and 14c (packing device).

The number and position of processing facilities, storage facilities, transport facilities, and the like may vary within the AEMP. The proposed arrangements enable fast and efficient transport within the AEMP. Combinations of the proposed arrangements may be used in different areas of the AEMP.

### LIST OF REFERENCES

1 Processing unit for medical devices
2 Entry on unclean side
4 Entry storage
6 Exit on sterile side
8 Exit storage
10a, b, c Robotic handling device
12 Transport unit
12a, b, c, d, e f, g Transport device
14a Pre-cleaning device
14b Cleaning and disinfection device
14c Packaging device
14d Sterilization device
16 Transport trolley
17 Loading trolley
18 Robot
19 Transport trolley
20 Sterile goods container
22 Robot
26 Washing table
28 Mesh basket
30 Transport chain
32 User interface
34, 36 Loading rack
38 Turnstile
40 Conveyor belt
42 Conveyor belt
44 Rail
46 Pullout
48 End point
50, 52 Rail
54 Storage place
56 Packing table
58 Junction
60 End point
100 Separation step
200 Transport step
300 Pre-cleaning step
400 Transport step
500 Cleaning and disinfection step
600 Transport step
700 Packing step
800 Transport step
900 Filling step

1-15. (canceled)

16. A processing unit for a medical instrument arranged in a sterile goods container, the processing unit comprising:
a robotic handling device for automated handling of the sterile goods container or automated handling of the sterile goods container and the medical instrument;
a processing device or a storage device for processing or storing the sterile goods container and/or the medical instrument;
a transport unit that is motor-driven for transporting the sterile goods container and/or the medical instrument; and
a transport chain formed by at least two of the devices and the transport unit,
the processing unit configured to:
provide manual transport in the transport chain within said at least two of the devices,
place the medical instrument in a mesh basket, and
package the medical instrument in a sterile goods barrier.

17. The processing unit according to claim 16, wherein:
the robotic handling device and the processing device or the storage device are each assigned a base area section, and
transport of the sterile goods container and/or the medical instrument is performed via the transport unit during an intended operation outside the base area sections.

18. The processing unit according to claim 17, wherein transport is carried out at least in sections via the transport unit and/or manually within the base area sections.

19. The processing unit according to claim 16, wherein the transport unit has at least one transportable loading device into which the medical instrument and/or the sterile goods container and/or sections of the sterile goods container are placeable for transport and/or processing.

20. The processing unit according to claim 19, wherein the transport unit is designed to transport the at least one transportable loading device between at least one of:
a first robotic handling device and a pre-cleaning device,
a pre-cleaning device and a cleaning and disinfection device,
a cleaning and disinfection device and a packing device,
a packing device and a second robotic handling device,
the second robotic handling device and a sterilization device,
a sterilization device and a third robotic handling device, or
a third robotic handling device and a storage device.

21. The processing unit according to claim 16, wherein the transport unit has at least partially two tracks.

22. The processing unit according to claim 16, wherein the transport unit has at least one intersection.

23. The processing unit according to claim 16, wherein the transport unit comprises a transport path that is located, supported or suspended at least in sections on a ceiling side and/or at least in sections on a floor side.

24. The processing unit according to claim 16, wherein the transport unit comprises at least one of:
at least one running rail arrangement,
a belt,
a belt arrangement,
a shuttle,
a gripper,
a robot arm, or
a lifting device.

25. The processing unit according to claim 16, wherein the processing unit comprises a plurality of processing devices arranged circumferentially around the robotic handling device.

26. The processing unit according to claim 16, wherein the processing unit comprises a plurality of processing devices arranged circumferentially at an end point or junction of the transport unit.

27. The processing unit according to claim 26, wherein the plurality of processing devices extend in a radial, star-shaped or circumferential manner.

28. The processing unit according to claim 16, wherein the processing unit comprises a plurality of processing devices distributed along the transport unit in a transport direction and extend parallel or transverse to the transport direction.

29. The processing unit according to claim 16, wherein the at least one robotic handling device is arranged at another end point or junction of the transport unit.

30. A method for operating a processing unit to process a sterile goods container and a medical instrument arranged in the sterile goods container, the processing unit having at least one robotic handling device for the sterile goods container or for the sterile goods container and the medical instrument, a processing device or a storage device for the sterile goods container and/or the medical instrument, and a transport unit for the sterile goods container and/or the medical instrument, the method comprising steps of:
automatically handling the sterile goods container, or the sterile goods container and the medical instrument, by the at least one robotic handling device;
processing or storing the sterile goods container and/or the medical instrument by the at least one processing device or storage device;
transporting the sterile goods container and/or the medical instrument in a transport chain formed by at least two of the devices and the transport unit,
placing the medical instrument in a mesh basket within the transport chain, and
packaging the medical instrument in a sterile goods barrier.
